(19) United States
(12) Patent Application Publication
(10) Pub. No.: US 2012/0078769 A1
(43) Pub. Date: Mar. 29, 2012

(54) METHOD, AGENT AND COMPUTER PROGRAM PRODUCT FOR STRATEGY SELECTION IN AUTONOMOUS TRADING AGENTS

(76) Inventors: Silvio Becher, Munchen (DE); Steffen Lamparter, Munchen (DE)

(21) Appl. No.: 12/893,045

(22) Filed: Sep. 29, 2010

(51) Int. Cl. G06Q 40/00

(52) U.S. Cl. 705/37

(57) ABSTRACT

In a method of strategy selection trading in autonomous trading agents, a plurality of information is perceived regarding characteristics of an autonomous trading agent, the plurality of information is transmitted and interpreted using a plurality of agent policies, a set of acceptable trading strategies is obtained and the acceptable trading strategies are further evaluated via a utility function, and an action within the utility function is executed and bids to be traded by the autonomous trading agents on a market are sent.

### TECHNICAL FIELD

The present invention describes a method of strategy selection in autonomous trading agents, an autonomous trading agent, and a computer program product for implementing an autonomous trading agent. More particularly, the present invention describes a generic strategy framework for policy directed autonomous trading agents.

### BACKGROUND

One of the fundamental questions asked in multi-agent systems research is how autonomous self-interested agents can be coordinated such that the global performance of the system is maximized. In recent years market mechanisms have become popular as efficient means for coordinating self-interested agents competing with each other for scarce resources or tasks. A wide range of different negotiation or action mechanisms have been proposed in this context, many of them exhibiting favorable properties such as efficiency and incentive compatibility. Incentive compatibility is an important feature in competitive multi-agent systems since the markets incentivize the autonomous agents to reveal their private information truthfully, for the market. Having full information from the participating agents the market can determine a global optimal solution that cannot easily be manipulated by malicious agents.

When using a market based coordination framework in a multi-agent system, the design of the agent's strategies for interacting with the market becomes an important element. In this context, in the art, several solutions have been proposed:

A solution focuses on user agent platforms such as Java agent development framework, JADE, or Cougar, Cou. While the solutions provide basic coordination, and some market mechanisms such as negotiation and auction protocols, these solutions do not support the agent developers in specifying domain specific agent strategies for participating in the coordination process. As a result, the development of agents is a very cumbersome and complicated process since for each resource and market mechanism different strategies are needed, and no designed time for strategy development is provided.

Another solution focuses on powerful systems implementing domain specific marketplaces. They provide means for developing the corresponding agent strategies. An example of such system is the trading agent competition described in “Designing the market game for a trading agent competition” by Wellman et al. This system provides a test bed for non-cooperative agent strategies.

Other commercially relevant application examples may be found within the financial domain, where the area of algorithmic trading has become increasingly important over the last years. However, these strategies are specific for a concrete market mechanism and domain. They are not geared towards highly configurable strategies that provide the flexibility to add the resources at run time. For example, when developing an agent-based energy market, agents representing households must adapt their strategy in a plug and play fashion when adding or removing appliances in the household. While publications such as “Designing bidding strategies for trading agents in an electronic auctions” by E. Gimenes-Funes et al., and “A framework for designing strategies for trading agents” by P. Vytelingum et al. address agent strategy design using more general settings, these approaches still lack the flexibility and configurability required to support highly configurable strategies.

Therefore, the problem still remains of how to provide for a strategy that allows the full participation of agents on the market, without permitting malicious agents to manipulate the market, while supporting the agent developers in specifying domain specific agent strategies for participating in the coordination process, and at the same time providing the flexibility and configurability required to support highly configurable strategies.

### SUMMARY

The above referenced problems are addressed and solved by the various embodiments.

According to an embodiment, a method of strategy selection in autonomous trading agents, may comprise the steps of: perceiving a plurality of information data regarding characteristics of an autonomous trading agent; transmitting and evaluating said plurality of information data using a plurality of agent policies; obtaining a set of acceptable trading strategies and further evaluating said acceptable trading strategies via a utility function, and executing an action comprised in an utility function and sending bids to be traded by the autonomous trading agents on a market system.

According to a further embodiment, the plurality of information data perceived may comprise at least one of market, environment and agent state information data. According to a further embodiment, the step of transmitting and evaluating said plurality of information data using a plurality of agent policies may comprise combining previously defined information data with agent policies given at the time of design. According to a further embodiment, policies can be a set of constrains that capture general rules that define admissible actions, constraining therefore a strategy space of an autonomous trading agent. According to a further embodiment, a strategy space of an autonomous trading agent at a time tₖ can be a Cartesian product:

Sᵢ (tₖ)=Mxθᵢ (tₖ)xA_{—}i,

wherein the Cartesian product is covering agent's I A_i, a plurality of possible states θᵢ(tₖ) and a plurality of market mechanism descriptions M. According to a further embodiment, a strategy s pertaining to the strategy space of an autonomous trading agent Sᵢ available to agent I may define which action should be executed for a given market mechanism m in a given state (θᵢ(tₖ), θ_{M}(tₖ), θ_{ε}(tₖ)) pertaining to Θᵢ(tₖ). According to a further embodiment, policies by constraining the strategy space define whether a certain action can be allowed for a market mechanism in a given state. According to a further embodiment, policies can be a set of constraints that have to be met by a solution to a certain problem.

According to another embodiment, an autonomous trading agent may comprise means of perceiving information data regarding a plurality of characteristics of an autonomous trading agent; means of transmitting and evaluating said information data using a plurality of agent policies and means of obtaining a set of acceptable trading strategies and further evaluating said acceptable trading strategies via a utility function, and means of executing an action comprised in the utility function and sending bids to be traded by the autonomous trading agents on a market system.

According to yet another embodiment, a computer program product for implementing an autonomous trading agent may execute: downloading a plurality of policies into the autonomous trading agent, creating an information layer, evaluating the plurality of agents' policies and obtaining a list of actions that autonomous trading agent may execute, and sending an action to a marketplace system where the autonomous trading agent is active based upon the evaluation of agent's plurality of policies.

According to a further embodiment of the computer program product, the list of policies may reside in a knowledge layer located on said autonomous trading agent, and the action may be sending a bid with a given price and quantity to the market place. According to a further embodiment of the computer program product, the sending an action to a marketplace system where the autonomous trading agent is active may occur in a behavioral layer defined on said autonomous trading agent.

### BRIEF DESCRIPTION OF THE DRAWINGS

Other objects and features of the various embodiments will become apparent from the following detailed descriptions considered in conjunction with the accompanying drawings. It is to be understood, however, that the drawings are designed solely for the purposes of illustration and not as a definition of the limits of the invention.

FIG. 1 represents an agent architecture.

FIG. 2 represents the bidding process, according to the strategy framework proposed by various embodiments.

FIG. 3 illustrates a flow chart of the method of strategy selection in autonomous trading agents proposed in accordance with one embodiment.

In the drawings, like reference numbers refer to like objects throughout. Objects in the diagrams are not necessarily drawn to scale.

### DETAILED DESCRIPTION

According to various embodiment, a generic strategy framework is proposed that supports developers in specifying device specific agents strategies. The framework presented by various embodiments can be used to implement widely autonomous bidding agents that are able to interact with different market mechanisms in various domains. To this end, it is proposed, in accordance with one of its embodiments, a method of strategy selection in autonomous trading agents, comprising at least perceiving a plurality of information data regarding the characteristics of an autonomous trading agent, transmitting and interpreting or evaluating the plurality of information data using a plurality of agent policies, obtaining a set of acceptable trading strategies, and further evaluating the acceptable trading strategies via a utility function, and executing an action comprised in the utility function and sending bids to be traded by the autonomous trading agents on a market system or market place. The execution of the action and sending the bids to be traded can be performed automatically.

In accordance with the method of strategy selection in autonomous trading agents proposed by various embodiments, the plurality of information data perceived or received comprises at least one of market, environment and agent state information. The step of transmitting and interpreting the plurality of information data using a plurality of agent policies comprises combining previously defined information with policies given at the time of design. The policies capture a set of constrains that are general rules that define admissible actions, constraining therefore a strategy space of an autonomous trading agent.

In the context of the method of strategy selection in autonomous trading agents according to various embodiments a strategy space of an autonomous trading agent at a time tₖ is for example a Cartesian product Sᵢ (tₖ)=Mxθᵢ(tₖ)xAᵢ, , wherein the Cartesian product is covering agent's I properties A_i, a plurality of possible states θᵢ(tₖ) and a plurality of market mechanism descriptions M. The strategy s pertains to the strategy space of an autonomous trading agent Sᵢ available to agent I and defines which action should be executed for a given market mechanism m in a given state (θᵢ(tₖ), θ_{M}(tₖ), θ_{ε}(tₖ)) pertaining to Θᵢ(tₖ). Further in the context of the method of strategy selection in autonomous trading agents according to various embodiments policies by constraining the strategy space define whether a certain action is allowed for a market mechanism in a given state. The policies are a set of constraints that have to be met by a solution to a certain problem.

It is further proposed in accordance with another of its embodiments an autonomous trading agent, comprising at least the means of perceiving information regarding a plurality of characteristics of an autonomous trading agent, means of transmitting and interpreting the information using a plurality of agent policies, means of obtaining a set of acceptable trading strategies and further evaluating the acceptable trading strategies via a utility function, and means of executing an action comprised in the utility function and sending bids to be traded by the autonomous trading agents on a market.

In accordance with a further yet embodiment, a computer program product is proposed for implementing an autonomous trading agent, the computer program executing downloading a plurality of policies into the autonomous trading agent, creating an information layer, evaluating the plurality of agents' policies and obtaining a list of actions that an autonomous trading agent may execute, and sending an action to be executed to a marketplace computer system where the autonomous trading agent is active based upon the evaluation of agent's plurality of policies.

In connection with the computer program product according to various embodiments, the list of policies pertains to a knowledge layer located on the autonomous trading agent and the action is sending a bid with a given price and quantity to the market place. Sending an action to a marketplace computer system where the autonomous trading agent is active occurs in a behavioral layer defined on the autonomous trading agent.

As discussed above, the various embodiments propose a strategy framework for coordinating decentralized autonomous agents that may be applied among others within a smart energy grid. The framework brings together the concept of policy-based computing and market-based coordination. In this context, agents can be seen as self-interested entities that are governed by their local policies. Efficient coordination between these self-interested agents is to be realized through a market mechanism that gives incentives to the agents to reveal their policies to the respective system or market. By knowing the agent policies, an efficient solution for the overall system can be determined. Leveraging a declarative policy-based approach facilitates the specification of highly customizable strategies that can be easily adapted to various resources and markets or systems. For example, the framework is used for efficient balancing of decentralized energy supply, provided from photovoltaic, wind power sources etc., and demand, by households and businesses, in a power grid.

The architecture proposed by various embodiments leverages policies for realizing a high degree of autonomy while making sure that the agents behave within a predefined action space. In accordance with various embodiments policies are a set of constrains that may comprise declarative descriptions that can be added or removed at run time, which allow adapting the strategies dynamically. For example, in the energy market scenario new appliances in the household may come with their policies regarding how they can be regulated. These policies can be used by the energy-trading agent to adapt its strategy to the new setting.

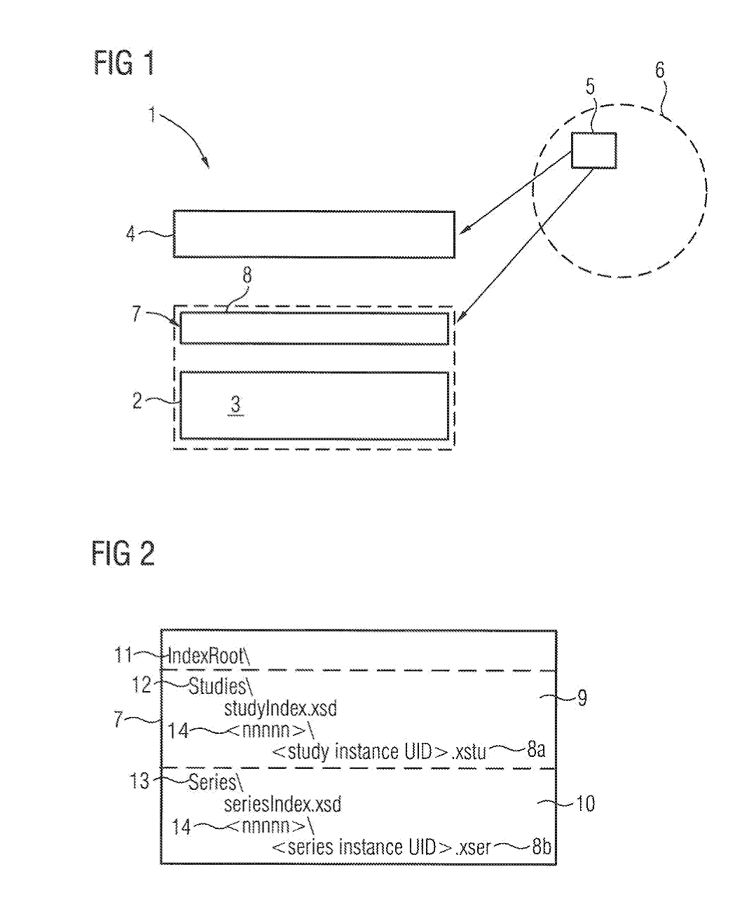

Referring now to FIG. 1, FIG. 1 represents an agent architecture.

Specifically, FIG. 1 represents the architecture 100 of an agent 200 that allows automated trading on the energy markets. By automated trading is meant the autonomous acquisition, storage and processing of information by the agent 200. The autonomous acquisition, storage and processing of information by the agent 200 is realized via at least the steps of perception 202, cognition 204 and action 206, that will be described in detail later in the present document. Each one of the steps of perception 202, cognition 204 and action 206 are assigned for execution to a layer pertaining to the agent architecture, the information layer 102, the knowledge layer 104 and the behavioral layer 106, each layer pertaining to the design of the agent's architecture 100.

In the following, the agent architecture 100 and its corresponding layers 102, 104 and 106 will be discussed in detail.

The information layer 102 contains information which an agent 200, denoted with I, and being one of a plurality of agents I, has gathered from various sources, such as the market, the environment and its own private information at a particular point in time, denoted with tₖ, k being one of a plurality of points in time N.

By market state, according to various embodiment, is understood information that is public and is available at a certain point in time tₖ. The market state may be defined via a vector

Θ_{M}(tₖ)=(x, Bₜₖ, priceₜₖ, qₜₖ) (1)

where, for an application where it is intended to purchase energy from an open market via an agent, via:
x is represented the trading object,
priceₜₖ is represented the clearing price,
qₜₖ is represented the overall traded quantity at time tₖ,
and via Bₜₖ are represented the orders to buy or sell energy which are present in the order book at time tₖ. In turn variable B is defined through the biding language in the market.

The agent's state at a time tₖ according to various embodiments is characterized by vector:

Θ₁ (tₖ)=(idᵢ, q_{1,tk}, v_{i,tk}, comp_{i,tk}) (2)

where id₁ specifies whether the agent acts as buyer or seller, Q_{i,tk} defines the quantity of energy required, or provided, by the agent at time tₖ,
v_{i,tk} defines the reservation price of an agent, and
comp_{1,tk} represent the computational resources available at a given time.

In addition to the market and agent state it might also be necessary to acquire additional information dependent on the application scenario. Assuming that the application is within a smart grid, where decentralized energy demand and supply is allocated using a market mechanism, the state of the power grid might also be relevant for the calculation of optimal allocation. As such, additional information data that is not perceived by the agent or market is added via the environment state, which captures this application-specific information.

In accordance with various embodiments, by environment state is meant information that captures the values of a set of application specific variables over time. The variables are not part of the agent itself, nor can they be observed on the market directly. They can rather be perceived by the agent when observing its direct environment. Typically information about environment states is perceived via sensors, such as the measurement of frequency or voltage in an electrical grid, and is aggregated to a higher level of abstraction that can be interpreted by the agents.

To summarize, in accordance with various embodiments, the agent performs a step of perception 202 in which, via information layer 102, information is gathered from heterogeneous data sources, the information comprising among others the market state, the agent state and the environment state.

In accordance with various embodiments, the agent 200 also performs a step of cognition 204 via a knowledge layer 104. On this layer, previously defined information is combined with policies given at the time of design. These policies are a set of constrains that capture general rules that define admissible actions and thereby constrain the strategy space of an agent.

In accordance with various embodiments, the strategy space S of a market agent 200 (I) at the time tₖ is defined as a Cartesian product

Sᵢ (tₖ)=Mxθᵢ (tₖ)xAᵢ (3)

that is covering agent's I actions Ai, the possible states θᵢ(tₖ) and the market mechanism descriptions M. Consequently, a strategy s pertaining to Sᵢ available to agent I defines which action a should be executed for a given market mechanism m in a given state (θᵢ(tₖ), θ_{M}(tₖ), θ_{ε}(tₖ)) pertaining to θᵢ(tₖ).

The description of a market mechanism is important, if more than one mechanism should be supported by the agent. Examples of such mechanisms are a one sided mechanisms like the English or Dutch actions or double actions. Several approaches are known regarding how the market processes can be formalized and described. For example, the game description language GDL formalizes games which are also general formulation of auction protocols using Datalog, and thereby also formally describing the auction space for the agents that can be reused in accordance with the strategy definition in accordance with various embodiments.

Policies are a set of constrains that are used to constrain the strategy space Si. By constraining the strategy space Si policies define whether a certain action is allowed for a market mechanism in a given state. In accordance to various embodiments, policies are a set of constraints that have to be met by a solution to a certain problem.

In literature, solving a problem specified by a set of constraints is called constraint satisfaction problem (CSP). A CSP is described by a set of attribute identifiers L, each representing one aspect of the problem, and the domains of these attributes D. Since in various embodiments it is aimed to specify constraints over the strategy space, it is assumed that D=S.

In accordance with various embodiments by constraint satisfaction problem is understood a tuple (L, S, Φ), where L represent the involved attributes of the problem, D the domains of these attributes, and Φ a set of constrains that defines whether a given configuration C pertains to C is D₁x . . . xDₙ is allowed or not.

A constraint consists of a scope and a relation, such as φ=(scp, rel).

The scope scp of a constraint is a k-tuple of attribute labels (l₁, . . . . , lₖ) pertaining to L′, and the relation rel of a constraint the set of k-tuples defining the allowed attribute values rel including D₁x . . . xDₖ for a given scope. Since an enumeration of all possible relations is often not feasible, due to the fact that there are infinite domains, the relationships are defined via predicates p_{φ}: D₁x . . . xDₖ→rel_{φ}.

A strategy s is evaluated with respect to a k constraint with

Scp_{φ}=(l₁, . . . , lₖ) and

rel_{φ}={(dₗ₁^{rel}, . . . . dₖ₁^{rel}), . . . , d_{lq}^{rel}, . . . , d_{kq}^{rel})}

as defined bellow:

$${G}_{φ} ( s ) = \{ \begin{matrix}1 if ∃ j ∈ [ 1 , q ] , ∀ i ∈ [ 1 , k ] \text{:} match ( {d}_{ij}^{rel} , {d}_{i}^{c} ) = true \\ 0 else\end{matrix} \qquad ( 4 )$$

The equation (4) is evaluated to 1 for a given constraint and a given strategy s if there is a tuple in the relation rel_{φ} for which each attribute value dᵢⱼ^{rel} matches the corresponding attribute valued; in the configuration.

The predicate match is used to compare two attribute values. In the simplest case, where attributes values represent “flat” data types, such as integers or strings, this could be realized by a simple syntactic comparison, for example match

(dᵢⱼ^{rel}, dᵢ^{s})=trueifᵢⱼ^{rel}=dᵢ^{s}.

In order to decide if a strategy is admissible, the following equation has to be valid for all constrains. This is ensured by:

$${G}_{φ} ( s ) = {\prod }_{φ ∈ Φ} {G}_{φ} ( s ) \qquad ( 5 )$$

Based on the evaluation of constrains, a set of acceptable strategies may be defined for the agent I by removing the strategies that violate at least one constraint:

Ŝᵢ{s ∈Sᵢ/G_{φ}(s)=1}

The set Ŝᵢ is therefore the strategy space that has to be considered in the behavioral layer where the best strategy is selected and executed.

The behavioral layer 106 is responsible for deciding on the best action to take at each point in time. In order to select an action, the strategies need to be ranked according to their preferences of the agent. This ranking may be done by utilizing a utility function.

The best strategy is determined in accordance with various embodiments by solving the following maximization problem:

$${s}^{′} = arg max {{u}_{i}}_{s ∈ \hat{S}} ( s )$$

Given the best strategy, an action a′ is executed in the tuple s′ which typically involves sending one or more bits to the market. The utility function and strategy space typically depend on the application scenario as well as the market mechanism used. In this context, the available set of actions A is determined by debating language off the market mechanism used.

For example, in a one-shot action only one bid can be sent to mechanism while in sequential action protocols more complex actions might be involved. Another important application or dependency is the selection of the best price that should be sent to the market. While for incentive compatible mechanisms, getting the real reservation price is the dominant equilibrium strategy for all agents (independent of the strategy of the other agents), for other market mechanisms this is not the case as a strategic over and under biding might increase the expected return for individual agents. Due to this scenario dependency in the later part of the present document a concrete example regarding the application of the picking strategy framework will be discussed in connection with a smart grid scenario.

To summarize, in accordance with various embodiments, market, environment, and agent state information are perceived in a perception step and passed along to a cognition step. During the cognition step the information or data is interpreted and evaluated using the agent policies. The evaluation leads to a set of acceptable strategies that are further evaluated using a given utility function. The action contained in the utility maximizing strategy is finally executed and the corresponding bids are sent to the market.

A representation of summary made above may be seen in FIG. 2. FIG. 2 represents the bidding process, according to the strategy framework proposed by various embodiments. For the sake of readability, the time dependency is omitted from FIG. 2.

In connection with the application of various embodiments within a smart grid agent the agent may be a software product, which runs on a device. The device comprises a communication interface to appliances (like a washing machine, an e-car, a photo voltaic device, etc.), sensors (for registering for example the temperature) and other data sources or services (such as weather services, price prediction services, market etc.). The agent uses these interfaces to obtain information like parameter, status information and to control the appliances. Furthermore, the agent can send and receive messages to the market by using the market interface, which may be implemented via a web service interface.

So the agent is the peace of software, which decides how the appliances should be configured and scheduled as a result interacting with the market. The agent is implemented as a state machine. In every state the agent fulfills a task, this leads to the next state. In the first state (during the perception step 202) the agent gathers information about the environment (e.g. temperature, weather), market (e.g. price history, market status, installed market auction) and the current situation of what the agent is representing (operation status of the appliances, fuel level of CHP, user preferences of the device's owner etc.). The perception state derives a strategy space regarding this information.

During the next task step, the cognition step the agent uses policies, which are provided from the appliances, which should be controlled. The policies are represented by constraints and express for example boundary conditions, technical properties, exception handling of the devices, etc. Exemplarily, if the washing machine is in the spin cycle, this cycle may not be interrupted. The constraints can be formulated using description logic or rule based languages. For example a software component called constraint solver is used to calculate a set of actions that are allowed regarding all constraints (policies). So the policies and the strategy space are the input parameter and a set of allowed strategies is the output or the result.

In the next state, the agent evaluates the output of the previous state using a utility function, so that the result is the strategy with maximum utilization with the property of incentive compatibility. The chosen strategy is executed by the agent, in the action step. The strategy describes how to interact with the market (sequences, bidding language, market rules), how the bid should look like (price, amount, etc.).

The agent receives a message from the market with what the result is (e.g. price, amount). The result could be the agent uses the communication interface to parameterize or control the appliances.

Today, and in the foreseeable future, the power networks are penetrated more and more by decentralized energy suppliers like wind power, photovoltaic and combined heat and power, that connect to the distribution grid with low and medium voltage. Some of the suppliers are also fluctuating and are controllable only within limited ranges. In order to achieve an economically, ecologically and stable energy network power generation and power consumption need to be balanced and such balancing and as such the balancing of supply and demand needs to be achieved. Therefore, producers and consumers need to be able to coordinate with each other using instantiating and local energy markets. Intelligent coordination mechanisms ensure an optimal balancing of the energy supply and demand, while guaranteeing that criteria related to grid capacity constraints and additional quality are met. The rationale behind using electronic markets or systems as a coordination mechanism is the decentralized nature of the scenario proposed by various embodiments, that operates without a fully informed central agent. In such a scenario where the self interested provider of consumer or pro-consumer agents try to optimize their personal utility in cooperation or competition with other agents a coordination mechanism must incentivize the individual agents to reveal their goals to reach a global optimum for the overall system. Having full information data from the participating agents the system can determine a global optimal solution that cannot be easily manipulated by malicious agents. Markets can provide efficient mechanisms in the presence of selfish agents that optimize social welfare in the market. As each of the appliances, and decentralized energy supplier require its own adapted bidding strategies and strategy framework based on policies can be seamlessly combined, thus providing the right means to realize customizable agent bidding strategies.

In order to fully specify a market mechanism the various embodiments define two further aspects: a bidding language for communicating the agent's preferences to the market and the mechanism itself consisting of an allocation function X and a pricing function P.

Generally a bidding language defines the preferences that an agent wants to reveal to the market, as bidding is about reporting the preference function vᵢ. When designing a bidding language there is a trade-off between the exclusivity of the language, the privacy loss of users, and the complexity of the market mechanism. For example, a bidding language supports expressing how valuation changes with time, over with the available units. For the energy scenario a restricted bidding language is recommended. As a result, an efficient mechanism may be implemented in the agents so they do not have to reveal a lot private data to the mechanism. Alternatively, this could lead to less efficient markets if dependencies between bids cannot be compensated with local agent intelligence and smart splitting of originally complex bids into simple bids. A general overview of the bidding language with different expressivities can be found at least in “Bidding and allocation in combinatorial auctions” by N. Nisan.

Based on these considerations, in accordance with one embodiment a set of requests to buy energy B^{R} are defined, and a set of offers to sell energy B^{o} are also defined.

Their relationships of

B⁰∩B^{R}=φ and B^{o}UB^{R}=B apply.

A bid each bᵢ∈B represents a tuple b=(vᵢ,qᵢ), where vᵢ defines the preservation prize for a single unit of the good x, for example, the maximal price for requests and minimal prices for offers, and
qᵢ:X→R⁺ defines how many units of the good are desired or provided.

If the good is energy, it is reasonable to assume divisibility, the overall reservation price for a good x being given by vᵢ(x)qᵢ(x) or simply vᵢqᵢ.

Having defined how agents submit their bids and asks to the market, the choice and payment functions can also be defined. Since in the energy market multiple producer and consumer agents are present, the mechanism design that will be described further in this document is a two-sided market mechanism called double auction or exchange. For the energy markets divisible bids, the partial execution of bids may be assumed. Further, for the energy markets a call market that allows the accumulation of bids over a period of time, buy-side and sell-side aggregation of bids and risk neutral agents with quasi-linear preferences may be assumed.

For a given set of requests and offers B^{R} and B^{o}, the winner determination is defined as an allocation function that maximizes the social welfare in the market. The corresponding linear program for winner determination may be defined as follows:

$${max}_{{z}_{i , j}} {\sum }_{{b}_{i} ∈ {B}^{R}} {\sum }_{{b}_{j} ∈ {B}^{o}} ( {v}_{i} ( x ) - {v}_{j} ( x ) {q}_{j} {z}_{ij} ) , where$$

$${\sum }_{{b}_{j} ∈ {B}^{o}} {q}_{j} ( x ) {z}_{ij} \leq {q}_{i} ( x ) , ∀ {b}_{i} ∈ {B}^{R}$$

$${\sum }_{{b}_{i} ∈ {B}^{R}} {z}_{ij} \leq 1 , ∀ {b}_{j} ∈ {B}^{o}$$

$$0 \leq {z}_{i , j} \leq 1$$

Unfortunately, defining the payment function and the mechanism as a whole in a way that the resulting double action is efficient, incentive compatible and budget balanced mechanism is generally impossible, as already stated by the seminal impossibility theorem of Myerson and Satterhwaite.

However it's possible to design a mechanism that meets at least two of the three desirable properties. Using the known Vickerey-Clark-Groves mechanism an efficient and incentive compatible auction may be obtained, but budget balance cannot be guaranteed anymore.

To calculate prices, the offers B^{o} have to be arranged in descending order (b₁, . . . , bⱼ, . . . , bₙ) and requests B^{R} in ascending order (a₁, . . . , aᵢ, . . . , aₘ) with regards to their prices.

When then, the index 1 is determined and with this index 1 the prize for buyers is set. Other approaches which implement a balanced budget mechanism are known from “A dominant strategy double auction” by R. P. McAfee.

Given to market mechanism specified, a bidding strategy can be further defined for energy markets using the agent strategy framework discussed above. As a wide range of different systems are connected to an energy grid, ranging from appliances of private households to complex industrial machines each of these systems has to implement different bidding strategies, the agent strategy framework of various embodiments greatly facilitates the system implementation task.

In the following the agent strategy framework of various embodiments will be illustrated in connection with how to define strategies for some typical smart grid agents.

First, the information layer has to be adapted to the smart grids market scenario. This requires to adapt the market state to the market mechanism

θ_{M}(tₖ)=(x, Bₜ_{ₖ}, priceₜ_{ₖ}, qₜ_{ₖ}), as it has been defined previously in the present document.

Since energy is a highly homogeneous good, the trading object x represents electricity according to IEC norm 60038:1983 with a predefined set of quality criteria, such as frequency between 50 Hz and a voltage level of 230V, with a tolerance of plus minus 10V. As the market mechanism does not reveal the bids of other participants it is assumed that B=φ. The priceₜₖ is a tuple (max(a¹,b^{ll1}),min(a^{l11},b¹)) representing the bid/ask spread in the market, and qₜₖ is the overall amount of electricity traded at time tₖ measured in kWh.

Second, the agent's private state

θᵢ(tₖ)=(idᵢ,q_{i,t}_{ₖ},v_{i,t}_{ₖ}, comp_{i,t}_{ₖ})

is adapted as follows: the agent is either a buyer, a seller or prosumer, therefore Idᵢ={seller, buyer, prosumer}, g_{i,t}_{ₖ} represents the maximum amount of electricity that can be provided/consumed by the agent I at time tₖ, v_{i,tk} is the maximal/minimal valuation of a single kwh electricity, and comp_{i,tk} is currently not used within the smart grid scenario.

Third, the environment state observable by all agents comprises information about the status of the electricity network that can be measured via sensors such as frequency and voltage, current and time (e_{f,t}_{ₖ}, e_{v,t}_{ₖ}, e_{c,t}_{ₖ}, t_{k,t}_{ₖ}).

In addition, specific sensor data might be available to some of the agents, which could include the current temperature within a fridge, the current load of a manufacturing machine, etc.

As discussed above in the knowledge layer general guidelines are specified regarding how a specific agent should behave. This is done by specifying a set of policies constraining the allowed strategy space.

In order to describe the policy driven approach a few examples will be given in the following regarding policies in the smart grid domain.

Demand profile: A consumer has to be able to specify its preferences with respect to the electricity demand. Typically, the overall required amount of electricity q_{i,t}_{ₖ}^{overall} is a split in an amount αq_{i,t}_{ₖ}^{overall} essentially required by an agent I and the disposable load (1−α)q_{i,t}_{ₖ} that is negotiable according to the market price. In this context α∈e[0,1] is the share of inflexible demand. Thus the minimal required load can be expressed by constraining part of the agent state, using the constraint

φ_{min Q}=(q_{i,t}_{ₖ}, rel_{minQ})

with

rel_{min Q}={q/q [symbol] αq_{i,t}_{ₖ}^{overall}}

Appliances specification: As the share of inflexible and negotiable energy depends on the appliances of the customer the demand profile can be constructed from individual policies coming with decent appliances. This also means that Φ_{min Q} could also be defined for individual appliances separately. In addition policies can regulate whether an appliance such as a refrigerator, industrial manufacturing machine, etc. can either reduce total load in time tₖ to some extent or shift load from time tₖ with high energy prices to a later point in time when energy prices are cheaper performing therefore load shedding. An example for a constraint defining that a certain quantity of load can be shifted within a timeframe can be done with the following policy

φ_{shedding}=({q_{i,t}_{ₖ}^{fridge}}, rel_{shedding}) with

rel_{shedding}={q_{i,t}_{ₖ}/Σ_{t∈[t}

s_{,t}_{ₖ}_{]}q_{i,t} [symbol] qᵢ^{fridge} [symbol] tₖ≦tₛ+ε}

analogously to the policies on customer side, policies for electricity producers can be defined. For example, each type of energy plant such as solar plants, wind turbines, or combined heat and power plants come with common policy sets that regulate whether or how production schedules can be changed dynamically, define the marginal costs, etc. In addition, policies may specify regulatory constrains important for the security of energy supplies or antitrust guidelines.

As policy specifications are purely declarative, policies from different appliances can be combined to policy sets Φ which are evaluated using 2 leading to the set of strategic policies. This proves to be a huge advantage for the framework and for the possibility of dynamically shaping the framework, since appliances are constantly added or removed and this capability should be supported in a plug and play fashion.

In the case of the energy grid application the action space is simply defied by A=R×R, where a tuple represents a bid b=(w,q) defining the maximal valuation of agent v and the required quantity q. As the dominant, and thus u maximizing strategy of rational agent is to reveal its true valuation and maximal quantity, the only rational action is to choose strategy s∈Ŝ with minimal deviation from v_{i,t}_{ₖ} and q_{i,t}_{ₖ} defined in θᵢ.

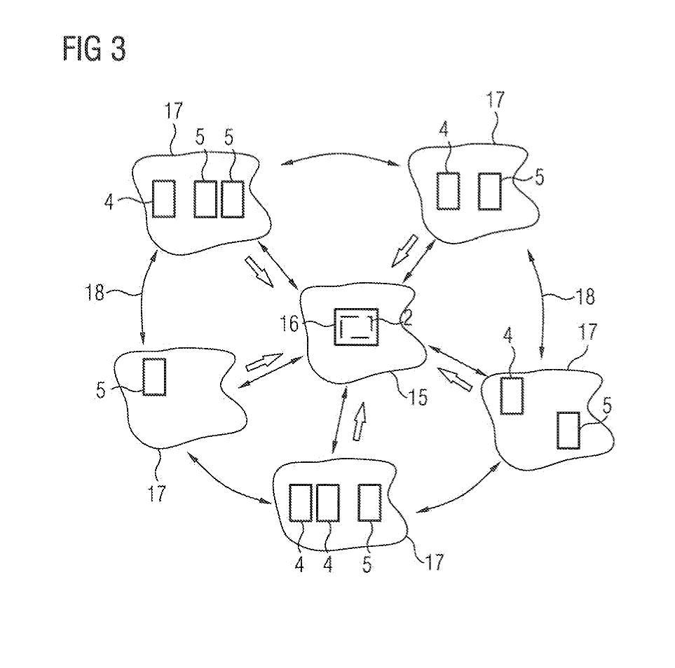

Therefore, to summarize, the method of various embodiments comprises, as it is as well illustrated in FIG. 3, the steps of perceiving 300 a plurality of information regarding characteristics of an autonomous trading agent, such as the market state denoted thought the present document with θ_{M}, the environment state denoted with θ_{ε} and the agents state denoted with θᵢ. The perception step 300 of the various information is followed by transmitting and interpreting 302 the plurality of information using a plurality of agent policies Φ and obtaining 304 a set of acceptable trading strategies and further evaluating 306 the acceptable trading strategies via a utility function, Ŝᵢ={s∈Sᵢ/G_{Φ}(s)−1} and in a step 308 executing an action comprised in the utility function and sending bids 310 to be traded by the autonomous trading agents on a market.

The autonomous trading agent of various embodiments is capable of performing the method and comprises at least means of perceiving information regarding a plurality of characteristics of an autonomous trading agent, means of transmitting and interpreting said information using a plurality of agent policies, means of obtaining a set of acceptable trading strategies and further evaluating said acceptable trading strategies via a utility function, and means of executing an action comprised in the utility function and sending bids to be traded by the autonomous trading agents on a market.

The computer program product proposed by further embodiments for implementing an autonomous trading agent is residing on the autonomous trading agent and is capable of executing at least the following actions: downloading a plurality of policies into the autonomous trading agent, creating an information layer, evaluating the plurality of policies and the agents constrains and obtaining a list of actions that autonomous trading agent may execute, and sending an action to a marketplace where the autonomous trading agent is active based upon the evaluation of agent's plurality of policies. The list of policies pertains to a knowledge layer located on said autonomous trading agent. The action of sending an action to a marketplace where the autonomous trading agent is active occurs in a behavioral layer defined on the autonomous trading agent.

Although the present invention has been disclosed in the form of embodiments and variations thereon, it will be understood that numerous additional modifications and variations could be made thereto without departing from the scope of the invention. For the sake of clarity, it is to be understood that the use of “a” or “an” through this application does not exclude a plurality, and “comprising: does not exclude other steps or elements. A “ unit”, or “module” can comprise a number of units or modules, unless otherwise stated.

What is claimed is:

1. A method of strategy selection in autonomous trading agents, comprising:
perceiving a plurality of information data regarding characteristics of an autonomous trading agent;
transmitting and evaluating said plurality of information data using a plurality of agent policies;
obtaining a set of acceptable trading strategies and further evaluating said acceptable trading strategies via a utility function, and
executing an action comprised in a utility function and sending bids to be traded by the autonomous trading agents on a market system.

2. The method of strategy selection in autonomous trading agents according to claim 1, wherein the plurality of information data perceived comprises at least one of market, environment and agent state information data.

3. The method of strategy selection in autonomous trading agents according to claim 1, wherein the step of transmitting and evaluating said plurality of information data using a plurality of agent policies comprises combining previously defined information data with agent policies given at the time of design.

4. The method of strategy selection in autonomous trading agents according to claim 3, wherein policies are a set of constrains that capture general rules that define admissible actions, constraining therefore a strategy space of an autonomous trading agent.

5. The method of strategy selection in autonomous trading agents according to claim 4, wherein a strategy space of an autonomous trading agent at a time tₖ is a Cartesian product:
Sᵢ (tₖ)=Mxθᵢ(tₖ)xA_{—}i,
wherein the Cartesian product is covering agent's I A_i, a plurality of possible states θᵢ(tₖ) and a plurality of market mechanism descriptions M.

6. The method of strategy selection in autonomous trading agents according to claim 4, wherein a strategy s pertaining to the strategy space of an autonomous trading agent Sᵢ available to agent I defines which action should be executed for a given market mechanism m in a given state (θₖᵢ (tₖ), θ_{M}(tₖ), θ_{ε}(tₖ)) pertaining to Θ₁ (tₖ).

7. The method of strategy selection in autonomous trading agents according to claim 4, wherein policies by constraining the strategy space define whether a certain action is allowed for a market mechanism in a given state.

8. The method of strategy selection in autonomous trading agents according to claim 7, wherein policies are a set of constraints that have to be met by a solution to a certain problem.

9. An autonomous trading agent, comprising:
means of perceiving information data regarding a plurality of characteristics of an autonomous trading agent;
means of transmitting and evaluating said information data using a plurality of agent policies, and
means of obtaining a set of acceptable trading strategies and further evaluating said acceptable trading strategies via a utility function, and
means of executing an action comprised in the utility function and sending bids to be traded by the autonomous trading agents on a market system.

10. The autonomous trading agent according to claim 9, wherein the plurality of information data perceived comprises at least one of market, environment and agent state information data.

11. The autonomous trading agent according to claim 9, wherein the means for transmitting and evaluating said plurality of information data using a plurality of agent policies are configured to combine previously defined information data with agent policies given at the time of design.

12. The autonomous trading agent according to claim 11, wherein policies are a set of constrains that capture general rules that define admissible actions, constraining therefore a strategy space of an autonomous trading agent.

13. The autonomous trading agent according to claim 12, wherein a strategy space of an autonomous trading agent at a time tₖ is a Cartesian product:
Sᵢ (tₖ)=Mxθᵢ (tₖ)xA_{—}i,
wherein the Cartesian product is covering agent's I A_i, a plurality of possible states θᵢ(tₖ) and a plurality of market mechanism descriptions M.

14. The autonomous trading agent according to claim 12, wherein a strategy s pertaining to the strategy space of an autonomous trading agent Sᵢ available to agent I defines which action should be executed for a given market mechanism m in a given state (θᵢ (tₖ), θ_{M} (tₖ), θ_{ε}(tₖ)) pertaining to Θᵢ(tₖ).

15. The autonomous trading agent according to claim 12, wherein policies by constraining the strategy space define whether a certain action is allowed for a market mechanism in a given state.

16. The autonomous trading agent according to claim 15, wherein policies are a set of constraints that have to be met by a solution to a certain problem.

17. A computer program product for implementing an autonomous trading agent, wherein the computer program when executed by a computer provides for:
downloading a plurality of policies into the autonomous trading agent,
creating an information layer,
evaluating the plurality of agents' policies and obtaining a list of actions that autonomous trading agent may execute, and
sending an action to a marketplace system where the autonomous trading agent is active based upon the evaluation of agent's plurality of policies.

18. The computer program product according to claim 17, wherein said list of policies resides in a knowledge layer located on said autonomous trading agent, and wherein said action is sending a bid with a given price and quantity to the market place.

19. The computer program product according to claim 17, wherein said sending an action to a marketplace system where the autonomous trading agent is active occurs in a behavioral layer defined on said autonomous trading agent.
